(19) United States
(12) Patent Application Publication
(10) Pub. No.: US 2014/0053413 A1
(43) Pub. Date: Feb. 27, 2014

(54) GARDEN SHEARS

(71) Applicant: Yao-Chung Huang, Fu Shing Hsiang (TW)

(72) Inventor: Yao-Chung Huang, Fu Shing Hsiang (TW)

(73) Assignee: HO CHENG GARDEN TOOLS CO., LTD., FU SHING HSIANG (TW)

(21) Appl. No.: 13/592,340

(22) Filed: Aug. 23, 2012

(51) Int. Cl. A01G 3/02; B26B 13/28

(52) U.S. Cl. 30/250; 30/252

(57) ABSTRACT

A garden shears has a main cutting body, a secondary cutting body and an applying arm. The main cutting body has a first shaft aperture at a middle section, a first blade disposed at one end aperture and a handle disposed on another end, the main cutting body has a first pivoting aperture between the first shaft aperture and the handle. The secondary cutting body has a second shaft aperture. A second blade is disposed at one end of the second shaft aperture and a sliding slot with a toothed portion at another end. The applying arm is pivoted with a gear at a middle section. The gear engages with the toothed portion of the sliding slot of the secondary cutting body, and the applying arm has a second pivoting aperture disposed at one end of the gear and a handle disposed at another end.

### BACKGROUND OF THE INVENTION

1. Field of the Invention

The present invention relates to garden shears, and more particularly to garden shears utilizes a gear and a toothed portion.

2. Description of the Related Art

Currently, one type of prior art garden shears, as shown in FIG. 6, has a main cutting body 40, a secondary cutting body 50 and an applying arm 60. The main cutting body 40 and the secondary cutting body 50 are pivoted together. The main cutting body 40 has a first blade 41 at one end and a longitude aperture 42 at another end. The secondary cutting body 50 has a second blade 51 corresponding to the main cutting body 40 at one end and a handle 52 at another end. One end of the applying arm 60 is pivoted onto the handle 52 of the secondary cutting body 50, and another forms a handle 61 corresponding to the secondary cutting body 50. Furthermore, the applying arm 60 has a limiting slot 62, and a shaft rod 63 is disposed through the limiting slot 62 and the longitude aperture 42 to form a linkage. The limiting slot 62 has a first opening 621, a second opening 622 and a third opening 623 corresponding to an outer side of the secondary cutting body 50 for engaging with the shaft rod 63. When the handles 52, 61 are pressed for operations, the applying arm 60 is pushes close to the secondary cutting body 50 to make the limiting slot 62 of the applying arm 60 to drive the shaft rod 63, and the shaft rod 63 pushes the longitude aperture 42 to control the main cutting body 40. Moreover, the shaft rod 63 changes the relative position between the limiting slot 62 and the longitude aperture 42 such that the shaft rod 63 can engage with the first opening 621, the second opening 622 or the third opening 623 for different degrees of opening between the blades 41, 51, so the user can gradually increase strength to the applying arm 60.

However, the above-mentioned prior art garden shears has following problems:

1. One end of the applying arm 60 is pivoted onto the secondary cutting body 50 and utilizes the limiting slot 62 to move the shaft rod 63 to provide different strength to the main cutting body 40. However, during the cutting process, the shaft rod 63 tends to slide along the longitude aperture 42 towards to the main cutting body 40 of the blade 41, which makes reduce the applying force to the main cutting body 40 applied the shaft rod 63.

2. The applying arm 60 utilizes the limiting slot 62 to press the shaft rod 63 to push the longitude aperture 42 of the main cutting body 40. But the limiting slot 62 and the longitude aperture 42 generates a clamping effect to the shaft rod 63 when the shaft rod 63 needs to slide between the limiting slot 62 and the longitude aperture 42, which causes strong resistance. Moreover, the relative position among the shaft rod 63, the limiting slot 62 and the longitude aperture 42 are not easy to maintain, which causes operation inconsistence.

3. The main and secondary cutting bodies 40, 50 are pivoted together, the secondary cutting body 50 and the applying arm 60 are pivoted together, and the applying arm 60 utilizes the limiting slot 62 to connect to the longitude aperture 42 of the main cutting body 40, but there is no safety mechanism to prevent the blades 41, 51 to open accidently.

Therefore, it is desirable to provide garden shears to mitigate and/or obviate the aforementioned problems.

### SUMMARY OF THE INVENTION

An objective of the present invention is to provide an easy garden shears.

In order to achieve the above mentioned objective, the garden shears comprises a main cutting body, a secondary cutting body and an applying arm. The main cutting body has a first shaft aperture at a middle section, a first blade disposed at one end aperture and a handle disposed on another end, the main cutting body has a first pivoting aperture between the first shaft aperture and the handle. The secondary cutting body has a second shaft aperture corresponding to the first shaft aperture of the main cutting body, to form a first pivoting point. A second blade is disposed at one end of the second shaft aperture and a sliding slot with a toothed portion at another end.

The applying arm is pivoted with a gear at a middle section. The gear engages with the toothed portion of the sliding slot of the secondary cutting body, and the applying arm has a second pivoting aperture disposed at one end of the gear and a handle disposed at another end. The second pivoting aperture and the first pivoting aperture of the main cutting body form a second pivoting point; a space between the first and the second pivot point being always shorter than a space between the first pivot point and the gear. When the first and second blades of the main and secondary cutting bodies are open apart, the space between the first pivot point and the gear is shorter than a space between the second pivot point and the gear; when the first and second blades of the main and secondary cutting bodies are close together, the space between the first pivot point and the gear is longer than a space between the second pivot point and the gear.

A benefit of the present invention is, the main and secondary cutting bodies are pivoted together to form the first pivot point A, the secondary cutting body and the applying arm are pivoted together to form the second pivot point B, the secondary cutting body and the applying arm utilize the toothed portion and the gear to engage together, so the handle of the applying arm is pivoted around the second pivot point B to make the gear to rotate another opposite side toothed portion 231, and the blade 22 of the secondary cutting body 20 is pivoted around the first pivot point A for cutting movements. When the gear presses the toothed portion 231 of the sliding slot, it provides an effort saving effect.

Another benefit of the present invention is, the secondary cutting body has the sliding slot and the toothed portion in the sliding slot, the applying arm is pivoted with the gear, when the gear engages with the toothed portion of the sliding slot, during the cutting movement, the gear rotates to reduce the cutting resistance and provide stability.

Another benefit of the present invention is, the gear and the toothed portion engages for better positioning, therefore, the gear and the toothed portion can maintain the relative position between the main and secondary cutting bodies, so the first and the second blades cannot open or close by accident.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of garden shears of an embodiment of the present invention.

FIG. 2 is an exploded perspective view of the garden shears of the embodiment of the present invention.

FIG. 3 is a schematic view showing the garden shears of the embodiment of the present invention being closed.

FIG. 4 is a schematic view showing the garden shears of the embodiment of the present invention being open.

FIG. 5 is a schematic view showing the garden shears of the embodiment of the present invention being operated.

FIG. 6 is a front view of prior art garden shears.

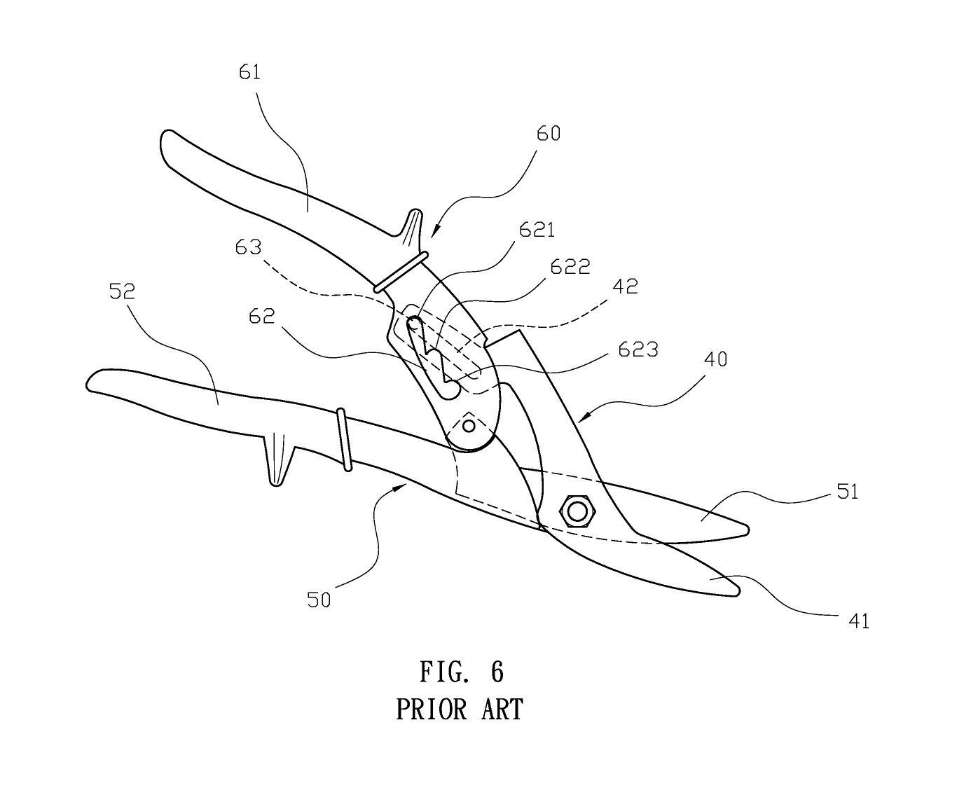

### DETAILED DESCRIPTION OF THE PREFERRED EMBODIMENT

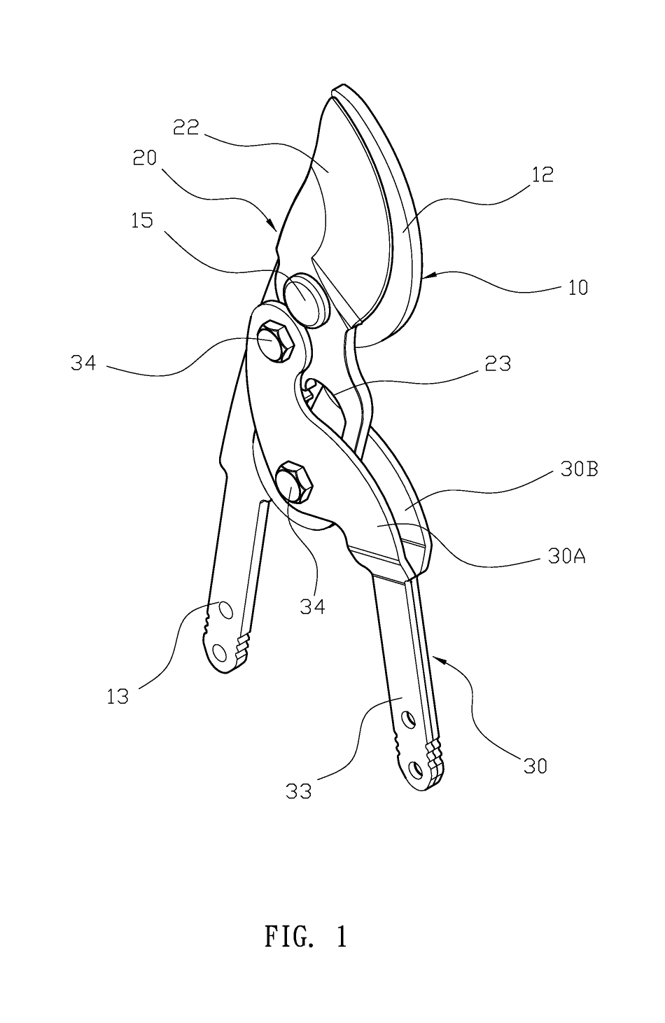

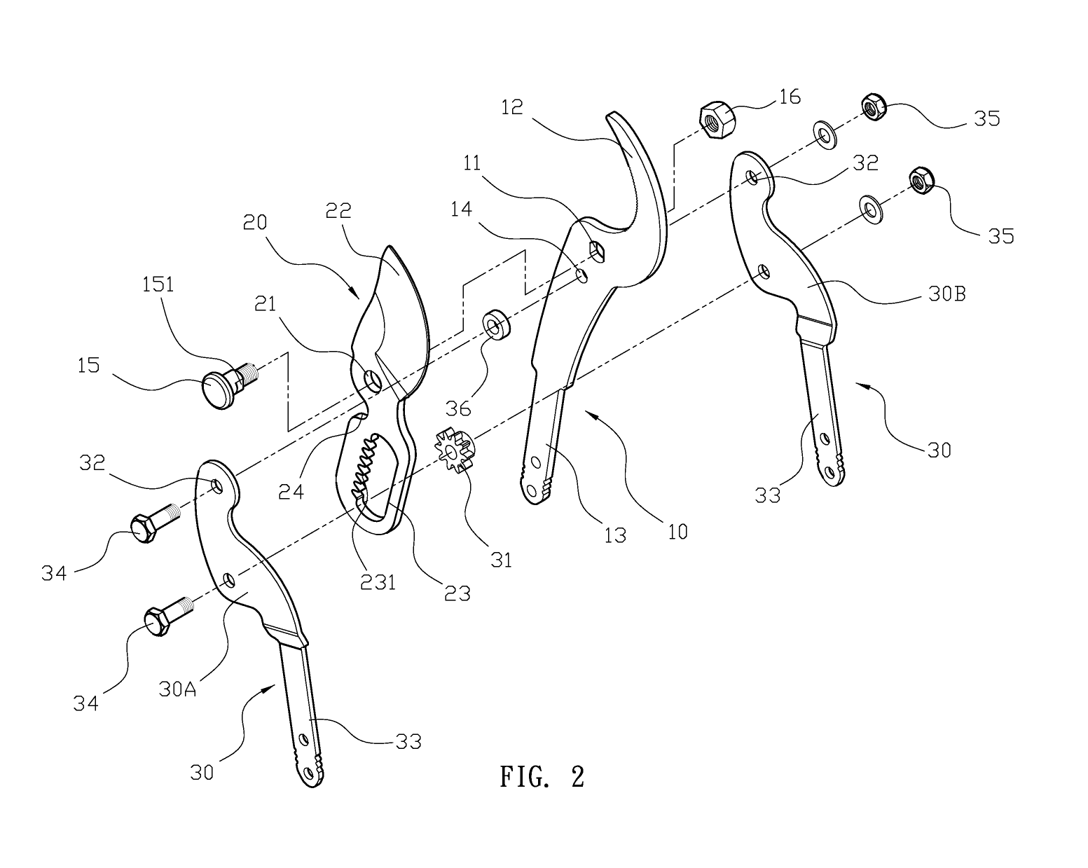

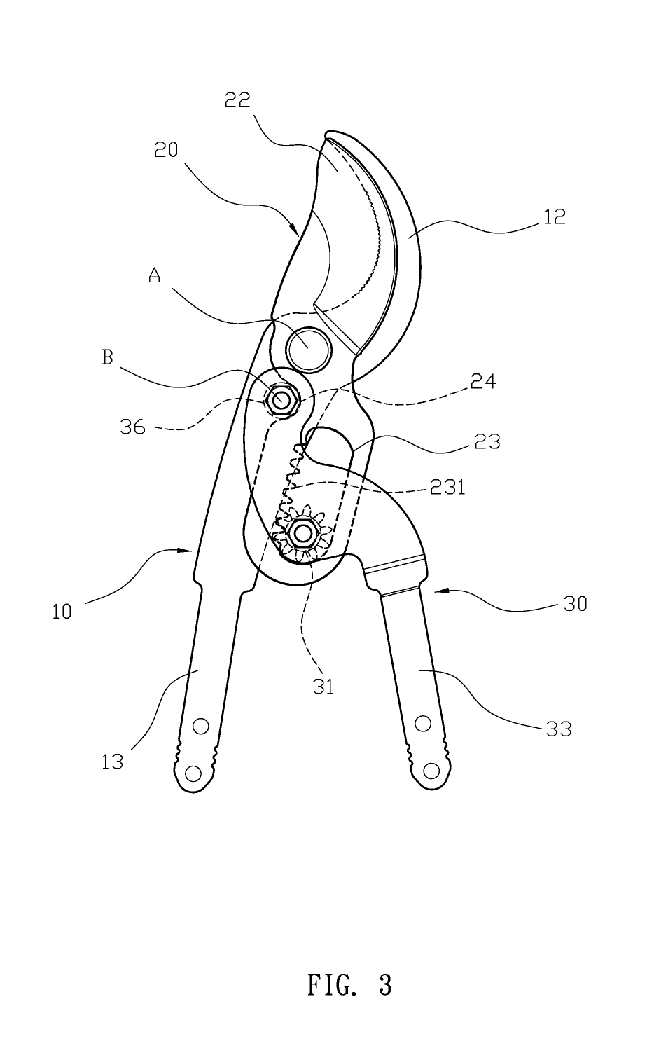

Please refer to FIG. 1, FIG. 2 and FIG. 3. Garden shears of a preferred embodiment has a main cutting body 10, a secondary cutting body 20 and a applying arm 30. The main cutting body 10 has a first shaft aperture 11 at a middle section, the main cutting body 10 has a blade 12 at one end and a handle 13 at another end of the first shaft aperture 11, and the main cutting body 10 has a first pivoting aperture 14 disposed between the first shaft aperture 11 and the handle 13. The secondary cutting body 20 has second shaft aperture 21 corresponding to the first shaft aperture 11 of the main cutting body 10 to form a first pivot point A. The first pivot point A utilizes a shaft rod 15 and a nut 16 to pivot the main and secondary cutting bodies 10, 20 together. The first shaft aperture 11 of the main cutting body 10 is a non-circular aperture, and the shaft rod 15 has a flat area 151 corresponding to the first shaft aperture 11 such that the shaft rod 15, the nut 16 and are the main cutting body 10 are secured together to prevent the nut 16 from being loosen. The secondary cutting body 20 has a blade 22 at one end of the second shaft aperture 21 and a sliding slot 23 at another end, the sliding slot 23 has a toothed portion 231. The first and the second blades 12, 22 of the main and secondary cutting bodies 10, 20 are a blade and an anvil. The applying arm 30 is pivoted with a gear 31 at a middle section, and the gear 31 engages with the toothed portion 231 of the sliding slot 23 of the secondary cutting body 20. The applying arm 30 has a second pivoting aperture 32 disposed at one end of the gear 31 and a handle 33 disposed at another end. The second pivoting aperture 32 and the first pivoting aperture 14 of the main cutting body 10 form a second pivoting B. Furthermore, the applying arm 30 is composed by two flat members 30A, 30B sandwiching the gear 31, and the applying arm 30 utilizes a bolt 34 and a nut 35 to attach the flat members 30A, 30B onto two sides of the sliding slot 23 of the secondary cutting body 20 and limit the gear 31 in the sliding slot 23. The two flat members 30A, 30B of the applying arm 30 sandwich a divider 36 at the second pivoting aperture 32 to position the main cutting body 10. The secondary cutting body 20 has a limiting slot 24 between the second shaft aperture 21 and the sliding slot 23, when the main and secondary cutting bodies 10, 20 are close together, the limiting slot 23 pushes against the divider 36 to prevent impact between the gear 31 and the sliding slot 23. With the above-mentioned structure, a space between the first and the second pivot point A, B being always shorter than a space between the first pivot point A and the gear 31. When the first and the second blades 12, 22 of the main and secondary cutting bodies 10, 20 are open apart, the space between the first pivot point A and the gear 31 is shorter than a space between the second pivot point B and the gear 31. When the first and the second blades 12, 22 of the main and secondary cutting bodies 10, 20 are closed together, the space between the first pivot point A and the gear 31 is longer than a space between the second pivot point B and the gear 31. Consequently, the handle 33 of the applying arm 30 is used as an applying point, the second pivot point B connecting the applying arm 30 and the main cutting body 10 is used as a pivot point, and the gear 31 presses the toothed portion 231 of the sliding slot 23 as a lever effect.

For actual assembly, please refer to FIG. 1, FIG. 2 and FIG. 3 again. The first shaft aperture 11 and the second shaft aperture 21 of the main and secondary cutting bodies 10, 20 are placed partially overlapped, the shaft rod 15 and the nut 16 pivot the main and secondary cutting bodies 10, 20 together and defined as the first pivot point A. The applying arm 30 utilizes the two flat members 30A, 30B to sandwich and pivot the gear 31 at the sliding slot 23 of the secondary cutting body 20, and the gear 31 is limited by the sliding slot 23 and engages with the toothed portion 231 of the sliding slot 23. Then, the bolt 34 and the nut 35 pivot the second pivoting aperture 32 and the first pivoting aperture 14 together and sandwich the divider 36 between the applying arm 30 and the main cutting body 10, to pivot the applying arm 30 and the main cutting body 10 together as the second pivot point B.

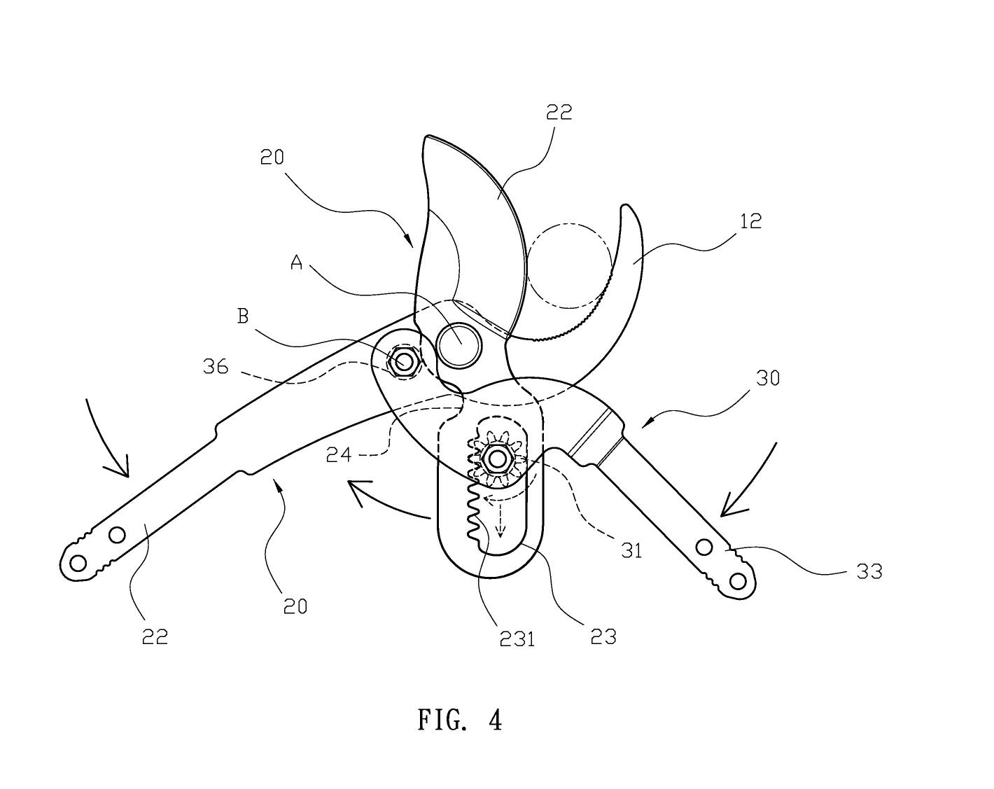

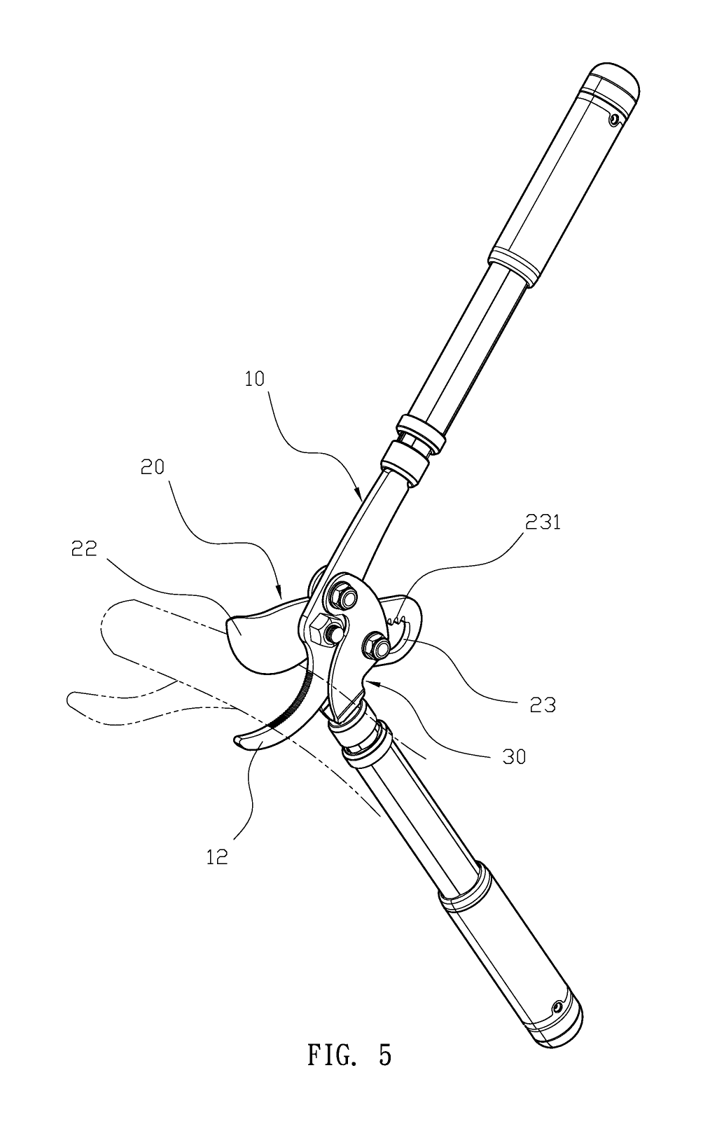

For actual operation, please refer to FIG. 2 to FIG. 5. The main cutting body 10 is pivoted with both of the secondary cutting body 20 and the applying arm 30, the engagement between the toothed portion 231 and the gear 31 is formed between the secondary cutting body 20 and the applying arm 30, therefore, the space between the first and the second pivot points A, B is always short than the space between the first pivot point A and the gear 31. As shown in FIG. 4, when the first and the second blades 12, 22 of the main and secondary cutting bodies 10, 20 are open apart, an object is placed in the opening between the first and the second blades 12, 22, the space between the first pivot point A and the gear 31 is short than the space between the second pivot point B and the gear 31. When the user presses the handles 13, 33 of the main cutting body 10 and the applying arm 30, the applying arm 30 utilizes the second pivot point B as a pivot point to make the gear 31 to press the toothed portion 231 of the sliding slot 23 and rotate towards to another opposite side of the toothed portion 231. Therefore, the blade 22 of the secondary cutting body 20 pivots around the first pivot point A to perform cutting movements. Moreover, as shown in FIG. 5, by extending the lengths of the handles 13,33, it can provide better effort saving effect. Since the gear 31 engages with the toothed portion 231 of the sliding slot 23, during the cutting movements, the gear 31 rotates to reduce the cutting resistance and provide stability. In addition, the gear 31 and the toothed portion 231 engages for better positioning, therefore, the gear 31 and the toothed portion 231 can maintain the relative position between the main and secondary cutting bodies 10, 20, so the first and the second blades 12, 22 cannot open or close by accident. Please refer to FIG. 3 again, when the first and the second blades 12, 22 of the main and secondary cutting bodies 10, 20 are closed together, the space between the first pivot point A and the gear 31 is longer than the space between the second pivot point B and the gear 31, so the limiting slot 24 of the secondary cutting body 20 pushes against the divider 36 to eliminate the impact between the gear 31 and the sliding slot 23. To open the first and the second blades 12, 22 of the main and secondary cutting bodies 10, 20, the user pulls the handles 13, 33 apart, which makes the gear 31 of the applying arm 30 to push against the sliding slot 23 to allow the first and the second blades 12, 22 to move again.

According to the above-mention structure, following benefits can be obtained: 1. The main and secondary cutting bodies 10, 20 are pivoted together to form the first pivot point A, the secondary cutting body 20 and the applying arm 30 are pivoted together to form the second pivot point B, the secondary cutting body 20 and the applying arm 30 utilize the toothed portion 231 and the gear 31 to engage together, so the handle 33 of the applying arm 30 is pivoted around the second pivot point B to make the gear 31 to rotate another opposite side toothed portion 231, and the blade 22 of the secondary cutting body 20 is pivoted around the first pivot point A for cutting movements. When the gear 31 presses the toothed portion 231 of the sliding slot 23, it provides an effort saving effect. 2. The secondary cutting body 20 has the sliding slot 23 and the toothed portion 231 in the sliding slot 23, the applying arm 30 is pivoted with the gear 31, when the gear 31 engages with the toothed portion 231 of the sliding slot 23, during the cutting movement, the gear 31 rotates to reduce the cutting resistance and provide stability. 3. the gear 31 and the toothed portion 231 engages for better positioning, therefore, the gear 31 and the toothed portion 231 can maintain the relative position between the main and secondary cutting bodies 10, 20, so the first and the second blades 12, 22 cannot open or close by accident.

Although the present invention has been explained in relation to its preferred embodiment, it is to be understood that many other possible modifications and variations can be made without departing from the spirit and scope of the invention as hereinafter claimed.

What is claimed is:

1. Garden shears comprising:
a main cutting body having a first shaft aperture at a middle section, a first blade disposed at one end aperture and a handle disposed on another end, the main cutting body having a first pivoting aperture between the first shaft aperture and the handle;
a secondary cutting body having a second shaft aperture corresponding to the first shaft aperture of the main cutting body, to form a first pivoting point, a second blade disposed at one end of the second shaft aperture and a sliding slot with a toothed portion at another end; and
an applying arm pivoted with a gear at a middle section, the gear engaging with the toothed portion of the sliding slot of the secondary cutting body, the applying arm having a second pivoting aperture disposed at one end of the gear and a handle disposed at another end; the second pivoting aperture and the first pivoting aperture of the main cutting body forming a second pivoting point; a space between the first and the second pivot point being always shorter than a space between the first pivot point and the gear; when the first and second blades of the main and secondary cutting bodies are open apart, the space between the first pivot point and the gear is shorter than a space between the second pivot point and the gear; when the first and second blades of the main and secondary cutting bodies are close together, the space between the first pivot point and the gear is longer than a space between the second pivot point and the gear.

2. The garden shears as claimed in claim 1, wherein the first and second blades of the main and secondary cutting bodies are a blade and an anvil.

3. The garden shears as claimed in claim 1, wherein the first pivot point utilizes a shaft rod and a nut to pivot the main and secondary cutting bodies together; the first shaft aperture of the main cutting body is a non-circular aperture, the shaft rod has a flat area corresponding to the first shaft aperture such that the shaft rod, the nut and are the main cutting body are secured together to prevent the nut from being loosen.

4. The garden shears as claimed in claim 1, wherein the applying arm is composed by two flat members sandwiching the gear, the applying arm utilizes a bolt and a nut to attach the flat members onto two sides of the sliding slot of the secondary cutting body and limit the gear in the sliding slot.

5. The garden shears as claimed in claim 4, wherein the two flat members of the applying arm sandwich a divider at the second pivoting aperture to position the main cutting body.

6. The garden shears as claimed in claim 5, wherein the secondary cutting body has a limiting slot between the second shaft aperture and the sliding slot, when the main and secondary cutting bodies are close together, the limiting slot pushes against the divider to prevent impact between the gear and the sliding slot.
